(19) United States
(12) Patent Application Publication
(10) Pub. No.: US 2016/0142693 A1
(43) Pub. Date: May 19, 2016

(54) METHOD AND APPARATUS FOR REPRESENTING COLOR GAMUT

(71) Applicant: SAMSUNG ELECTRONICS CO., LTD., Suwon-si (KR)

(72) Inventors: Oh-yun KWON, Seoul (KR); Tae-hwan CHA, Yongin-si (KR); Dong-wook KIM, Suwon-si (KR)

(21) Appl. No.: 14/927,843

(22) Filed: Oct. 30, 2015

(30) Foreign Application Priority Data
Nov. 18, 2014 (KR) 10-2014- 0160878

(51) Int. Cl. H04N 9/73; G06F 3/14

(52) U.S. Cl. CPC H04N 9/73; G06F 3/1415

(57) ABSTRACT

A method of displaying a color gamut includes: determining a color gamut for all gradations with respect to a display apparatus; and displaying the determined color gamut for all the gradations in a three-dimensional (3D) form on the display apparatus.

### CROSS-REFERENCE TO RELATED APPLICATION

This application is based on and claims priority under 35 U.S.C. §119 to Korean Patent Application No. 10-2014-0160878, filed on Nov. 18, 2014, in the Korean Intellectual Property Office, the disclosure of which is incorporated by reference herein in its entirety.

### BACKGROUND

1. Field

The disclosure relates to methods and apparatuses for displaying a color gamut, and for example, to methods and apparatuses for providing color gamuts for all gradations, which are obtained before and after color calibration is performed on a display apparatus, respectively.

2. Description of Related Art

As there is increasing demand for high-performance cameras or monitors, and a level of users' knowledge about display apparatuses is enhanced, it has become important that color representation performance and function of high image quality display apparatuses may be easily and conveniently understood.

Accordingly, information about whole specifications of display apparatuses, which are currently provided, is provided in a separate manual or included in each display apparatus so that users may use the information.

However, generally, before a display apparatus is released into a market, a color gamut is tested and adjusted only in a full-white gradation (R: 255, G: 255, B: 255), and information about a specification of the display apparatus is provided to a user only with reference to a color gamut in the full-white gradation.

Accordingly, if a gradation with respect to a display apparatus, purchased by a user, is decreased to a low gradation, a color gamut for a gradation that a user wants may not be accurately predicted.

### SUMMARY

Provided are methods and apparatuses for displaying a color gamut for each gradation, which is performed by a display apparatus, so that accurate and convenient color calibration can be performed on the display.

Additionally, a non-transitory computer-readable recording storage medium is provided, having stored thereon a computer program which, when executed by a computer, performs the methods.

Additional aspects will be set forth in part in the description which follows and, will be apparent from the description.

According to an example, a method of displaying a color gamut includes: determining a color gamut for all gradations with respect to a display apparatus; and displaying the determined color gamut for all the gradations in a three-dimensional (3D) form on the display apparatus.

Determining the color gamut may include determining three color coordinates forming a boundary of the color gamut.

Displaying the color gamut may include displaying the color gamut and the three color coordinates together.

Determining the color gamut may include determining a color reproduction coverage as a ratio of an area of an intersection between the color gamut and a unique standard color space of the display apparatus to the unique standard color space, and displaying the color gamut may include displaying the color gamut and the three color coordinates together.

The method may further include: performing color calibration for adjusting a color gamut for at least one gradation from among the color gamut for all the gradations; and re-displaying a color gamut for all gradations with respect to the display apparatus on which the color calibration is performed, in a 3D form.

Re-displaying the color gamut may include displaying at least one selected from the group consisting of the color gamut for all the gradations with respect to the display apparatus on which the color calibration is performed, three color coordinates forming a boundary of the color gamut with respect to the display apparatus on which the color calibration is performed, and a color reproduction coverage that is a ratio of an area of an intersection between the color gamut with respect to the display apparatus on which the color calibration is performed, and a unique standard color space of the display apparatus on which the color calibration is performed to the unique standard color space.

Re-displaying the color gamut may include displaying a result of applying the color calibration to a predetermined test image included in the display apparatus.

According to an example, a display apparatus includes: a color gamut analyzer or analyzing circuitry configured to determine a color gamut for all gradations with respect to the display apparatus; and a display configured to display the determined color gamut for all the gradations in a three-dimensional (3D) form on the display apparatus.

The color gamut analyzer or analyzing circuitry may determine three color coordinates forming a boundary of the color gamut, and the display may display the color gamut and the three color coordinates together.

The color gamut analyzer or analyzing circuitry may be configured to determine a color reproduction coverage as a ratio of an area of an intersection between the color gamut and a unique standard color space of the display apparatus to the unique standard color space, and the display may display the color gamut and the three color coordinates together.

The display apparatus may further include a color gamut calibrator or calibration circuitry configured to perform color calibration to adjust a color gamut for at least one gradation from among the color gamut for all the gradations, wherein the display re-displays a color gamut for all gradations with respect to the display apparatus on which the color calibration is performed, in a 3D form.

The display may display at least one selected from the group consisting of the color gamut for all the gradations with respect to the display apparatus on which the color calibration is performed, three color coordinates forming a boundary of the color gamut with respect to the display apparatus on which the color calibration is performed, and a color reproduction coverage that is a ratio of an area of an intersection between the color gamut with respect to the display apparatus on which the color calibration is performed, and a unique standard color space of the display apparatus on which the color calibration is performed to the unique standard color space.

The display may display a result of applying the color calibration to a predetermined test image included in the display apparatus.

A non-transitory computer-readable recording storage medium is provided having stored thereon a computer program which, when executed by a computer, performs the method.

### BRIEF DESCRIPTION OF THE DRAWINGS

These and/or other aspects will become apparent and more readily appreciated from the following detailed description, taken in conjunction with the accompanying drawings in which like reference numerals refer to like elements, and wherein:

FIG. 1 is a conceptual diagram illustrating a system for selecting a gradation with respect to a display apparatus and displaying a color gamut of the display apparatus in a three-dimensional (3D) form.

FIG. 2 is a block diagram illustrating an example display apparatus for displaying a color gamut;

FIG. 3 illustrates an example color gamut according to a decrease in a gradation represented by the display apparatus;

FIG. 4 is a flowchart illustrating an example of displaying and providing a color gamut for all gradations in a 3D form to a user, which are performed by the display apparatus; and

FIG. 5 illustrates an example of displaying a color gamut in a 3D form, which is performed by the display apparatus.

### DETAILED DESCRIPTION

Reference will now be made in detail examples which are illustrated in the accompanying drawings, wherein like reference numerals refer to like elements throughout. In this regard, the examples may have different forms and should not be construed as being limited to the descriptions set forth herein. Accordingly, the examples are illustratively described below, by referring to the figures, to explain aspects. Expressions such as “at least one of,” when preceding a list of elements, modify the entire list of elements and do not modify the individual elements of the list.

Examples will be described in detail with reference to the accompanying drawings. It may be understood, however, that there is no intent to limit the examples to the particular forms disclosed, for example, the examples are intended to cover all modifications, equivalents, and alternatives falling within the scope of the disclosure.

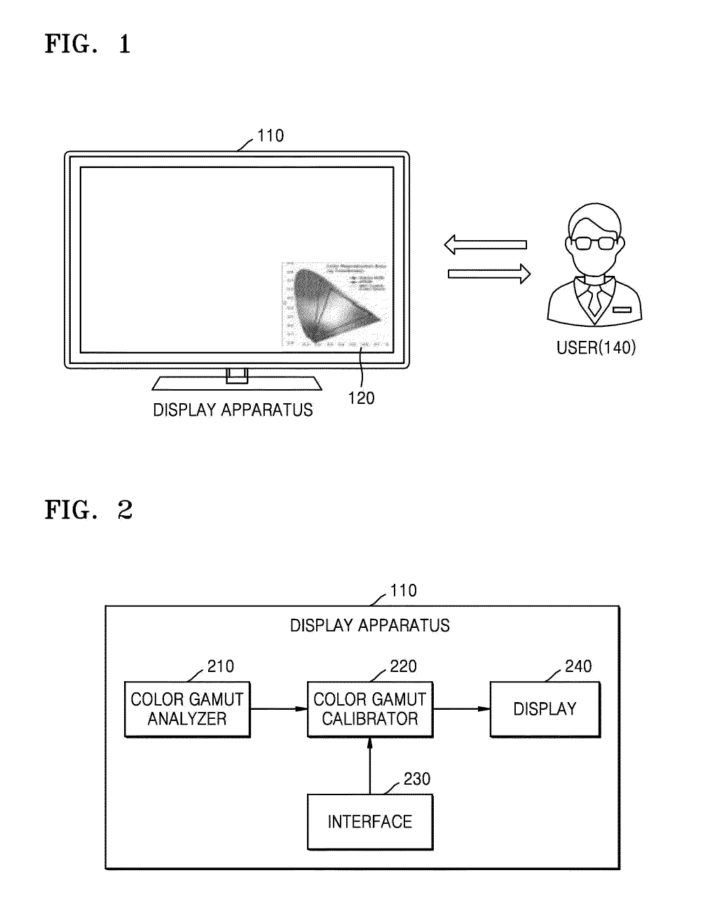

FIG. 1 is a conceptual diagram illustrating an example system for selecting a gradation with respect to a display apparatus 100 and displaying a color gamut of the display apparatus 100 in a three-dimensional (3D) form.

The display apparatus 110 may, for example, include a television, a monitor, a camera, a cellular phone, a tablet personal computer (PC), a mobile device, or the like, but is not limited thereto. The display apparatus 110 may, for example, display an image according to a unique standard color space. A standard color space refers, for example, to an area in which colors may be represented, from among a whole band of visible light that may be recognized by a human's eyes. The standard color space may be, for example, a color space such as standard red green blue (sRGB), AdobeRGB, society of motion picture and television engineers (SMPTE)-C, recommendation (REC.) 709, European broadcasting union (EBU), or Doppler color imaging (DCI), etc.

Before the display apparatus 110 is released from a factory, a color gamut, which is an area of colors that may be represented by the display apparatus 100, may be tested and adjusted by a manufacturer. The display apparatus 110 may display a color gamut on a display screen in the form of an on-screen display (OSD) 120.

Generally, a ratio of an area of an intersection between a standard color space and a color gamut to an area of the standard color space, expressed in percentage, is referred to as a color reproduction coverage. According to an example embodiment, a color reproduction coverage with respect to the display apparatus may refer to a ratio of an area of a triangle formed of three points such as red (R), green (G), and blue (B) to an area of a triangle formed of national television standards committee (NTSC) coordinates in an international commission on illumination (CIE) color coordinate system. However, a color reproduction coverage with respect to the display apparatus 100 is not always determined based on NTSC coordinates, and may also be determined compared to another standard color space.

A gradation refers, for example, to a degree of brightness that may be represented by the display apparatus 110. A gradation may, for example, refer to relative brightness or absolute brightness. Since light that may be sensed by a human includes a red component, a green component, and a blue component, a gradation may include a gradation of a red component of a pixel, a gradation of a green component of the pixel, and a gradation of a blue component of the pixel.

Before the display apparatus 110 is released from a factory, a color gamut, which is, for example, an area of colors that may be represented by the display apparatus 100, may be tested and adjusted by a manufacturer. Generally, a color gamut with maximum brightness, that is, a color gamut for a full-white gradation, is adjusted to correspond to a gamut of a standard color space. For example, a color gamut of the display apparatus 110 is adjusted with reference to a full-white gradation, and numerical information about a color reproduction coverage of the adjusted color gamut may be provided to a user 140.

However, the user 140 may view or edit an image displayed by the display apparatus 110, by selecting a low gradation with respect to the display apparatus 110. In this case, the user 140 needs information about a color gamut in a selected gradation with respect to the display apparatus, in order to determine whether the display apparatus 110 is capable of representing colors of an image without distortion in the selected gradation. Therefore, according to an example embodiment, the display apparatus 110 may determine a color gamut with respect to all gradations, and provide the color gamut to the user 140. The color gamut for all the gradations includes a color gamut for each of the gradations.

A color gamut with respect to all the gradations may be represented in a 3D form. For example, the display apparatus 110 may represent a color gamut with respect to all the gradations by showing a color gamut along x- and y-axes (or with a color coordinate that forms a boundary of the color gamut), and showing a change in the gradations along a z-axis. The display apparatus 110 may provide a 3D UI showing a color gamut for all the gradations so that the user 140 may accurately and conveniently use the display apparatus 110.

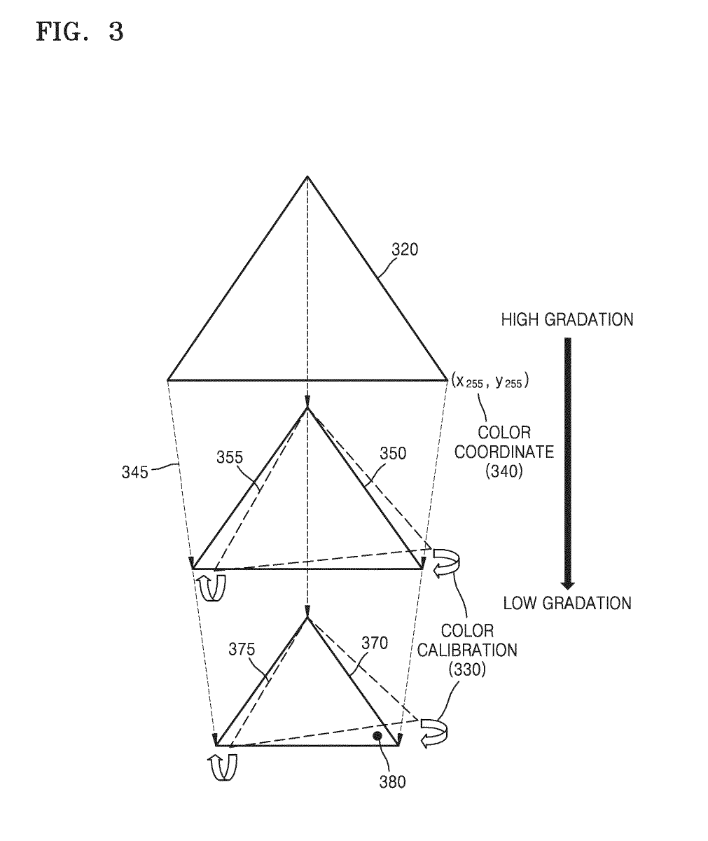

The user 140 may perform color calibration on the display apparatus 110 with reference to the color gamut for all the gradations. Color calibration refers, for example, to adjustment of a color gamut of the display apparatus 110 according to characteristics of a standard color space so as to represent a color desired by the user 140 in a gradation desired by the user 140. Color calibration may be performed by a method using a software algorithm stored in the display apparatus 110. Color calibration may be performed on all gradations with respect to the display apparatus 110 and, after the color calibration is performed, a color gamut for all the gradations with respect to the display apparatus 110 may be provided to the user 140. The color calibration is described in detail with reference to FIG. 3.

FIG. 2 is a block diagram illustrating an example display apparatus 110 for displaying a color gamut.

A color gamut analyzer 210 may be in the form of color gamut analyzing circuitry configured to analyze a current color gamut of the display apparatus 110. For example, the color gamut analyzer 210 may determine a unique standard color space of the display apparatus 110. An example of the standard color space may be sRGB, AdobeRGB, SMPTE-C, REC.709, EBU, or DCI, but is not limited thereto.

The color gamut analyzer 210 may determine an increase or a decrease in a color gamut according to an increase or a decrease in a gradation. According to an example embodiment, the color gamut analyzer 210 may determine all gradations that may be represented by the display apparatus 110 and a color gamut for all the gradations. If the display apparatus 110 has an 8-bit gradation, 256 gradations are present, and the color gamut analyzer 210 may analyze a color gamut according to 256 gradations.

According to an example embodiment, the color gamut analyzer 210 may analyze information about color coordinates that form a boundary of a color gamut. A color coordinate that forms a boundary of a color gamut may have a 2D or higher-dimensional value. The color gamut analyzer 210 may also determine a color reproduction coverage according to gradations which represents a ratio of an area of an intersection between a standard color space and a color gamut according to gradations to an area of the standard color space.

Additionally, the color gamut analyzer 210 may reanalyze a color gamut for all gradations represented by the display apparatus 110 after a color gamut calibrator 220 which may be in the form of calibration circuitry, is configured to perform color calibration.

The color gamut calibrator 220 may calibrate a color gamut of the display apparatus 110 with respect to a particular gradation according to characteristics of the standard color gamut. If a gradation with respect to the display apparatus 110 is decreased, a color gamut may be also reduced, and a triangle representing the color gamut may rotate in a left or right direction or a shape of the triangle may be changed. If a coordinate of a color in a gradation that the user 140 wants is not located in a current color gamut, the user 140 may re-perform color calibration on the display apparatus 110 using information about a color gamut that is linearly or non-linearly changed according to a change in a gradation, so that the current color gamut includes a coordinate of a color that the user 140 wants to represent. This will be described later with reference to FIG. 3. The color gamut calibrator 220 may employ a physical method or an algorithm of software so as to perform color calibration.

An interface 230 may provide an interface for selecting a gradation with respect to the display apparatus 110. The interface 230 may be in a form of a scroll bar or an edit box.

The interface 230 may provide an interface for performing color calibration on the display apparatus 110. If a request for color calibration is transmitted to the color gamut calibrator 220 via the interface 230, the color gamut calibrator 220 may calibrate a color gamut for one or more gradations shown by the display apparatus 110 according to characteristics of the standard color space.

If a gradation is selected or color calibration is performed, the color gamut analyzer 210 may re-analyze a color gamut that may be represented in the selected gamut. The color gamut analyzer 210 may determine a color coordinate (x, y) forming a boundary of the color gamut that is linearly or non-linearly reduced when a gradation is decreased from a high gradation to a lower gradation. Additionally, since the color gamut analyzer 210 analyzes a color gamut for all gradations which may be represented by the display apparatus 110 before a gradation is changed, the color gamut analyzer 210 has information about color coordinates that form a boundary of the color gamut. Additionally, the color gamut analyzer 210 may re-determine a color gamut for all gradations that may be represented by the display apparatus 110 after color calibration is performed on the display apparatus 110.

A display 240 may display at least one selected from the group consisting of the color gamut for all the gradations which is analyzed by the color gamut analyzer 210, information about the color coordinates forming the boundary of the color gamut, and a color reproduction coverage to the user 140. The display 240 may display the color gamut for all the gradations in the 3D form. For example, the display 240 may display the color gamut in the 3D form by displaying the color gamut (or color coordinates forming the boundary of the color gamut) along the x- and y-axes, and showing a change in the gradation along the z-axis. Additionally, the display 240 may display and provide only a color gamut for a particular gradation to the user 140. The display apparatus 110 may provide a 3D user interface (UI) for showing a color gamut for all gradations so that the user 140 may accurately and conveniently use the display apparatus 110.

According to an example embodiment, the display 240 may display a color gamut for all gradations, color coordinates, and a color reproduction coverage of the color gamut. For example, if the user 140 decreases a gradation from 60 Institute of Radio Engineers (IRE) to 30 IRE, the display 240 may display and provide, to the user 140, at least one selected from the group consisting of a color gamut, color coordinates, and a color reproduction coverage in a gradation of 30 IRE which are calculated by the color gamut analyzer 210.

If the color gamut calibrator 220 performs color calibration, the display 240 may update the color gamut, the color coordinates, and the color reproduction coverage with respect to the color-calibrated display apparatus 110, and display the updated color gamut, color coordinate, and color reproduction coverage to the user 140.

According to an example embodiment, the display apparatus 110 may apply a color-calibration algorithm employed by the color gamut calibrator 220 to a certain test image included in the display apparatus 110, and display a result of applying the color calibration to the test image on the display 240 to provide the result to the user 140.

FIG. 3 illustrates an example color gamut according to a decrease in a gradation with respect to the display apparatus 100.

As described above, the display apparatus 110 may analyze a color gamut for all gradations that may be represented by the display apparatus 100 and provide the color gamut to the user 140. Additionally, according to an example embodiment, the display apparatus 110 may provide color gamuts for all gradations to the user 140, which are obtained before and after color calibration is performed on the display apparatus 110, respectively.

FIG. 3 is a diagram illustrating an example reduction in a color gamut of the display apparatus 110 as a gradation is changed from a high to low gradation. Triangles 320, 355, and 375 respectively represent color gamuts in a particular gradation. For example, the triangle 320 shown in an uppermost location may represent a color gamut in a full-white gradation. A boundary of each color gamut is formed of three color coordinates 340, and each color coordinate (vertices of triangles shown in FIG. 3) is not provided here.

As shown in FIG. 3, a color gamut shown as the triangle 320 may be decreased as a gradation of the display apparatus 110 is decreased. An arrow 345 shown in a dotted line points to a color gamut that is linearly decreased according to a change in a gradation. For example, according to an example embodiment, a size of the color gamut 320 in a full-white gradation with respect to the display apparatus 110 may be reduced like a color gamut shown as a triangle 350 or 370, but the color gamut 320 still retains characteristics of the standard color space.

However, most color gamuts of the display apparatus 110 may be non-linearly reduced as a gradation is decreased from a high to low gradation, due to a problem in hardware or software such as a problem in a manufacture of a panel of the display apparatus 110. For example, if a gradation is decreased, a triangle representing a color gamut of the display apparatus 100 may rotate in a left or right direction or a shape of the triangle may be changed. Unlike the color gamuts 350 and 370 which respectively match the standard color space, the color gamuts 355 and 375 may be twisted. Accordingly, if accurate information about a color gamut that may be represented by the display apparatus 110 is provided to the user 140, the user 140 may perform color calibration 330 with reference to the color gamut whose accurate information is provided.

The user 140 may calibrate the color gamuts 355 and 375 that are non-linearly changed according to a change in a gradation, in correspondence with characteristics of the standard color space. For example, if a coordinate 380 of a color that is to be represented by the user 140 in a particular gradation is not located in the current color gamut 375, the user 140 may perform the color calibration 330 on the display apparatus 110 so that the current color gamut 375 includes the color coordinate 380, and thus, obtain a calibrated color gamut 370. The color calibration 330 may performed by using a physical method, e.g., digital circuitry, or an algorithm of software stored in the display apparatus 110. The user 140 may enhance compensation performance with respect to a whole color gamut by compensating for the color gamut that is reduced when a lower gradation compared to a high gradation is selected, by performing the color calibration 330.

According to an example embodiment, after color calibration is performed on the display apparatus 110, the display apparatus 110 may provide information about a color gamut for all gradations with respect to the display apparatus 110 to the user 140 in a 3D form.

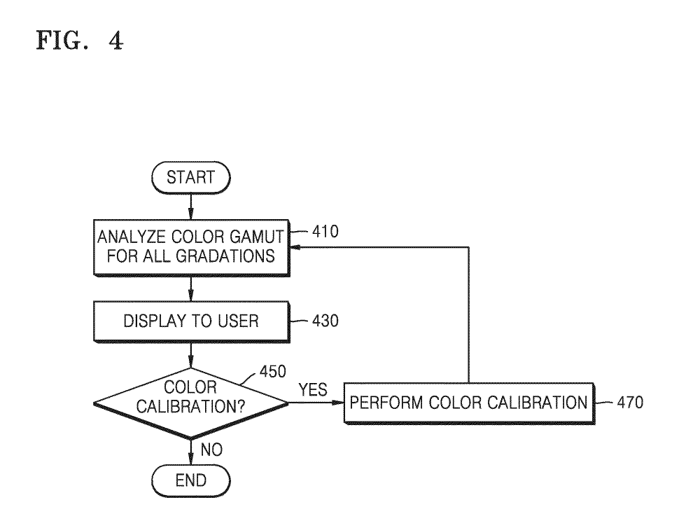

FIG. 4 is a flowchart illustrating an example of displaying a color gamut for all gradations in a 3D form and providing the color gamut to a user, which are performed by the display apparatus 110.

FIG. 4 is a flowchart illustrating an example method of displaying a color gamut for all gradations, which is performed by the display apparatus 110 shown and described with reference to FIGS. 1 through 3. Accordingly, it will be understood that descriptions that were provided with respect to the display apparatus 110 shown in FIGS. 1 through 3 may also be applied to the method of displaying a color gamut, which is performed by the display apparatus 110 according to an example embodiment, even if the descriptions are not provided here again.

In operation 410, the display apparatus 110 may analyze a color gamut of the display apparatus 110. According to an example embodiment, the display apparatus 110 may determine a unique standard color space of the display apparatus 110. An example of the standard color space may be sRGB, AdobeRGB, SMPTE-C, REC.709, EBU, or DCI, but is not limited thereto.

In operation 410, the display apparatus 110 may determine an increase or a decrease in a size of a color gamut as a gradation is increased or decreased. According to an example embodiment, the display apparatus 110 may determine information about a color coordinate (x, y) that forms a boundary of the color gamut. If the display apparatus 110 represents a gradation in 8 bits, 256 gradations may be present and the display apparatus 110 may analyze a color gamut for the 256 gradations, respectively.

In operation 410, the display apparatus 110 may determine a color reproduction coverage representing a ratio of an area of an intersection between a standard color space and the color gamut according to gradations to an area of the standard color space.

In operation 430, the display apparatus 110 may display the analyzed color gamut for all the gradations to the user. According to an example embodiment, the display apparatus 110 may display the color gamut for all the gradations in a 3D form and provide the color gamut to the user. For example, the display apparatus 110 may display the color gamut for all the gradations in a 3D form, by displaying the color gamut (or color coordinates forming boundaries of the color gamut) along the x- and y-axes, and displaying a change in the gradations along the z-axis. According to an example embodiment, the display apparatus 110 may display and provide the color gamut, the color coordinates forming boundaries of the color gamut, and a color reproduction coverage to the user. The display apparatus 110 may provide a 3D UI showing the color gamut for all the gradations so that the user 140 may accurately and conveniently use the display apparatus 110.

In operation 450, the display apparatus 110 may determine whether a color gamut of the display apparatus 110 in a particular gradation needs to be calibrated according to characteristics of the standard color space. As described above, if a gradation with respect to the display apparatus 110 is decreased, a color gamut may be also decreased, but since the color gamut may be non-linearly decreased according to characteristics of the display apparatus 100, if color calibration on the color gamut of the display apparatus 110 is needed, operation 470 is performed.

In operation 470, the display apparatus 110 may perform color calibration on a color gamut of the display apparatus 110. According to an example embodiment, the display apparatus 110 may perform color calibration using a color-calibration algorithm, and the color-calibration algorithm may be determined in consideration of characteristics of hardware used by the display apparatus 110 or characteristics of the standard color space. In operation 470, after the color calibration is performed on a color gamut of the display apparatus 110, the analyzing of the color gamut for all the gradations with respect to the display apparatus 110 in operation 410 and the displaying of the calibrated color gamut to the user in operation 430 may be performed again. According to an example embodiment, the display apparatus 110 may apply the color-calibration algorithm employed by the color gamut calibrator 220 to a certain test image included in the display apparatus 110, and display and provide a result of applying the color calibration to the test image to the user 140.

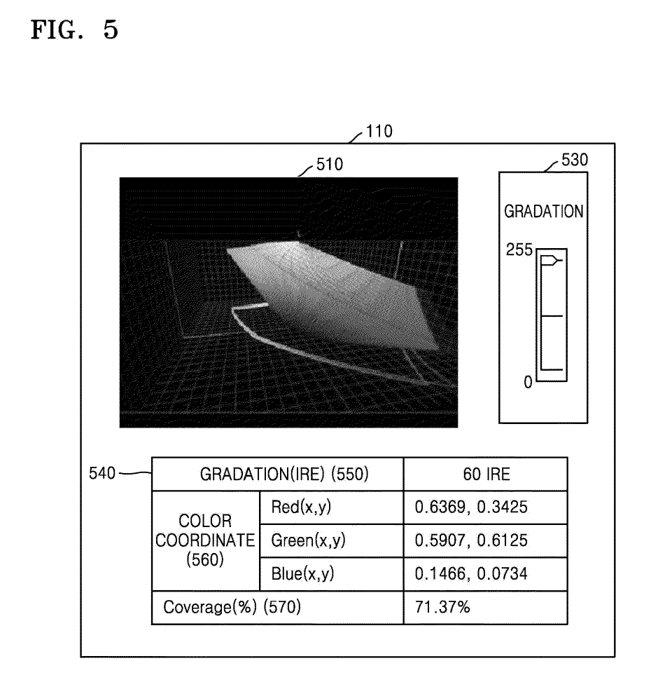

FIG. 5 illustrates displaying a color gamut in a 3D form, which is performed by the display apparatus 110.

A 3D graphic 510 refers to gradations with respect to the display apparatus 110 and a color gamut according to the gradations, which are represented by the display apparatus 110 in a 3D form. According to an example embodiment, the display apparatus 110 may display a change in a color gamut according to gradations in the 3D form, by showing color coordinates along x- and y-axes and a change in the gradations along a z-axis.

According to an example embodiment, a scroll bar 530 refers to an interface for changing a gradation with respect to the display apparatus 110. The display apparatus 110 may provide an interface for easily controlling a gradation by using a scroll bar 530 or an edit box, or the like. The interface may, for example, be implemented in the form of a remote controller or a button.

A table 540 shows an example embodiment of providing color coordinates 560 and a color reproduction coverage 570 with respect to a color gamut for a particular gradation 550 of 60 IRE, which is performed by the display apparatus 110. For example, it may be understood that, if the gradation 550 with respect to the display apparatus 110 is 60 IRE, color coordinates in a color gamut are (0.6369, 0.3425) for red, (0.2907, 0.6125) for green, and (0.1466, 0.0734) for blue, and the display apparatus 110 may represent a color gamut of 71.37% with reference to a standard color space.

As described above, if a gradation is changed or color calibration is performed with respect to the display apparatus 110, respective values of the gradation 550, the color coordinates 560, and a color reproduction coverage 570 may be changed, and the display apparatus 110 may provide the color coordinates 560 and the color reproduction coverage 570 to the user which are obtained before and after the color calibration is performed, respectively.

The method of displaying a color gamut can also be implemented as computer-readable codes on a non-transitory computer-readable recording medium. The non-transitory computer-readable recording medium is any data storage device that can store data which can be thereafter read by a computer system. Examples of the non-transitory computer-readable recording medium include read-only memory (ROM), random-access memory (RAM), CD-ROMs, magnetic tapes, floppy disks, optical data storage devices, and carrier waves such as data transmission through the Internet. The non-transitory computer-readable recording medium can also be distributed over network coupled computer systems so that the computer-readable code is stored and executed in a distributed fashion. As described above, and will be appreciated by those skilled in the art, the described systems, methods and techniques may be implemented in digital electronic circuitry including, for example, electrical circuitry, logic circuitry, hardware, computer hardware, firmware, software, or any combinations of these elements. Apparatus embodying these techniques may include appropriate input and output devices, a computer processor, and a computer program product tangibly embodied in a non-transitory machine-readable storage device or medium for execution by a programmable processor. A process embodying these techniques may be performed by a programmable hardware processor executing a suitable program of instructions to perform desired functions by operating on input data and generating appropriate output. The techniques may be implemented in one or more computer programs that are executable on a programmable processing system including at least one programmable processor coupled to receive data and instructions from, and transmit data and instructions to, a data storage system, at least one input device, and at least one output device. Each computer program may be implemented in a high-level procedural or object-oriented programming language or in assembly or machine language, if desired; and in any case, the language may be compiled or interpreted language. Suitable processors include, by way of example, both general and special purpose microprocessors. Generally, a processor will receive instructions and data from a read-only memory and/or a random access memory. Non-transitory storage devices suitable for tangibly embodying computer program instructions and data include all forms of computer memory including, but not limited to, non-volatile memory, including by way of example, semiconductor memory devices, such as Erasable Programmable Read-Only Memory (EPROM), Electrically Erasable Programmable Read-Only Memory (EEPROM), and flash memory devices; magnetic disks, such as internal hard disks and removable disks; magneto-optical disks; Compact Disc Read-Only Memory (CD-ROM), digital versatile disk (DVD), Blu-ray disk, universal serial bus (USB) device, memory card, or the like. Any of the foregoing may be supplemented by, or incorporated in, specially designed hardware or circuitry including, for example, application-specific integrated circuits (ASICs) and digital electronic circuitry. Thus, methods for providing image contents described above may be implemented by a program including an executable algorithm that may be executed in a computer, and the program may be stored and provided in a non-transitory computer readable medium.

It should be understood that example embodiments described herein should be considered in a illustrative sense only and not for purposes of limitation. Descriptions of features or aspects within each example embodiment should typically be considered as available for other similar features or aspects in other example embodiments.

While one or more example embodiments have been described with reference to the figures, it will be understood by those of ordinary skill in the art that various changes in form and details may be made therein without departing from the spirit and scope as defined by the following claims.

What is claimed is:

1. A method of displaying a color gamut, comprising:
determining a color gamut for all gradations with respect to a display apparatus; and
displaying the determined color gamut for all the gradations in a three-dimensional (3D) form on the display apparatus.

2. The method of claim 1, wherein determining the color gamut comprises determining three color coordinates forming a boundary of the color gamut, and displaying the color gamut comprises displaying the color gamut and the three color coordinates together.

3. The method of claim 1, wherein determining the color gamut comprises determining a color reproduction coverage as a ratio of an area of an intersection between the color gamut and a unique standard color space of the display apparatus to the unique standard color space, and
displaying the color gamut comprises displaying the color gamut and the three color coordinates together.

4. The method of claim 1, further comprising:
performing color calibration to adjust a color gamut for at least one gradation, from among the color gamut for all the gradations; and
re-displaying a color gamut for all gradations with respect to the display apparatus on which the color calibration is performed in the 3D form.

5. The method of claim 4, wherein re-displaying the color gamut comprises displaying at least one selected from the group consisting of the color gamut for all the gradations with respect to the display apparatus on which the color calibration is performed, three color coordinates forming a boundary of the color gamut with respect to the display apparatus on which the color calibration is performed, and a color reproduction coverage as a ratio of an area of an intersection between the color gamut with respect to the display apparatus on which the color calibration is performed, and a unique standard color space of the display apparatus on which the color calibration is performed, to the unique standard color space.

6. The method of claim 4, wherein the re-displaying of the color gamut comprises displaying a result of applying the color calibration to a predetermined test image included in the display apparatus.

7. A display apparatus comprising:
color gamut analyzing circuitry configured to determine a color gamut for all gradations with respect to the display apparatus; and
a display configured to display the determined color gamut for all the gradations in a three-dimensional (3D) form on the display apparatus.

8. The display apparatus of claim 7, wherein the color gamut analyzing circuitry is configured to determine three color coordinates forming a boundary of the color gamut, and
the display displays the color gamut and the three color coordinates together.

9. The display apparatus of claim 7, wherein the color gamut analyzing circuitry is configured to determine a color reproduction coverage as a ratio of an area of an intersection between the color gamut and a unique standard color space of the display apparatus to the unique standard color space, and
the display displays the color gamut and the three color coordinates together.

10. The display apparatus of claim 7, further comprising:
color gamut calibration circuitry configured to perform color calibration to adjust a color gamut for at least one gradation, from among the color gamut for all the gradations,
wherein the display re-displays a color gamut for all gradations with respect to the display apparatus on which the color calibration is performed, in the 3D form.

11. The display apparatus of claim 10, wherein the display displays at least one selected from the group consisting of the color gamut for all the gradations with respect to the display apparatus on which the color calibration is performed, three color coordinates forming a boundary of the color gamut with respect to the display apparatus on which the color calibration is performed, and a color reproduction coverage as a ratio of an area of an intersection between the color gamut with respect to the display apparatus on which the color calibration is performed, and a unique standard color space of the display apparatus on which the color calibration is performed, to the unique standard color space.

12. The display apparatus of claim 10, wherein the display displays a result of applying the color calibration to a predetermined test image included in the display apparatus.

13. A non-transitory computer-readable recording storage medium having stored thereon a computer program which, when executed by a computer, performs the method of claim 1.
